(19) United States
(12) Patent Application Publication
(10) Pub. No.: US 2019/0128257 A1
(43) Pub. Date: May 2, 2019

(54) PUMP APPARATUS

(71) Applicant: Newer Commuter, LLC, Burbank, CA (US)

(72) Inventor: Andrew C. Scherer, Burbank, CA (US)

(73) Assignee: Newer Commuter, LLC, Burbank, CA (US)

(21) Appl. No.: 16/173,454

(22) Filed: Oct. 29, 2018

Related U.S. Application Data
(60) Provisional application No. 62/612,486, filed on Dec. 31, 2017.
(60) Provisional application No. 62/578,832, filed on Oct. 30, 2017.

(51) Int. Cl. F04C 13/00; F04C 2/14; F04C 15/00

(52) U.S. Cl. CPC F04C 13/002; A23L 25/10; F04C 15/0038; F04C 2/14

(57) ABSTRACT

A pump apparatus can include a suction tube, a pliable sealing ring, and an actuator mechanism coupled to the suction tube. The suction tube can be configured to be removably coupled to a container in which the viscous fluid is arranged and be fluidly coupled to an interior of the container and to an output port for outputting the viscous fluid. The pliable sealing ring can be configured to sealingly engage with an interior wall of the container. When the suction tube is coupled to the container and the pliable sealing ring is sealingly engaged with the interior wall of the container, actuating the actuator mechanism can cause the viscous fluid to be suctioned upwardly through the suction tube and output from the output port, ambient air to be drawn into the container, and the pliable sealing ring to move downwardly.

### CROSS-REFERENCE TO RELATED APPLICATIONS

This application claims the benefit of U.S. Provisional Application Ser. No. 62/612,486, filed on Dec. 31, 2017 and U.S. Provisional Application No. 62/578,832, filed on Oct. 30, 2017. The disclosure of each of the above applications is incorporated herein by reference in its entirety.

### FIELD

The present disclosure relates to a pump apparatus, and more particularly to a pump apparatus for pumping of a viscous fluid, e.g., peanut butter.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A pump can be used to conveniently and efficiently extract a fluid out of a container. For this reason, pumps are used in many common household products, such as bottles for shampoo, hair conditioner, lotion, soap and other fluid containers. For fluids that flow relatively easily, a simple hand pump can be used. Such hand pumps are typically configured to use suction to extract the fluid. As fluid is output from the pump, the remaining fluid in the container flows to the suction port of the pump for future extraction.

For fluids that flow less easily (referred to herein as “viscous fluids”), however, such simple hand pumps may not perform well. For example only, instead of the fluid flowing to the suction port of the pump, an air channel may form from the suction port to the ambient air and cause the pump to pump air rather than the viscous fluid. In such cases, a user may shake the container in order to tamp down or otherwise move the fluid to the suction port in order to use the pump. This may be time consuming and quite annoying for the user.

A pump apparatus with improved performance at extracting such viscous fluids from a container would be desirable.

### SUMMARY

In some aspects, the present disclosure is directed to a pump apparatus that can be particularly efficient in outputting a viscous fluid. The pump apparatus can include a cap, a suction tube, a pliable sealing ring, and an actuator mechanism coupled to the suction tube. The cap can be configured to be removably coupled to a container in which the viscous fluid is arranged and define a suction tube aperture. The suction tube can extend through the suction tube aperture and have a first end and a second end. The first end of the suction tube can be configured to be arranged in an interior of the container and the second end can be fluidly coupled to an output port for outputting the viscous fluid. The pliable sealing ring can be sealingly engaged with the suction tube and be configured to further sealingly engage with an interior wall of the container. When the first end of the suction tube is arranged in the viscous fluid in the interior of the container and the pliable sealing ring is sealingly engaged with the interior wall of the container, actuating the actuator mechanism can cause the viscous fluid to be suctioned upwardly through the suction tube and output from the output port, ambient air to be drawn into the container, and the pliable sealing ring to move downwardly.

In additional aspects, the present disclosure is directed to a pump apparatus that can include a suction tube, a pliable sealing ring, and an actuator mechanism coupled to the suction tube. The suction tube can be configured to be removably coupled to a container in which the viscous fluid is arranged and have a first end and a second end. The first end can be configured to be fluidly coupled to an interior of the container and the second end can be fluidly coupled to an output port for outputting the viscous fluid. The pliable sealing ring can be configured to sealingly engage with an interior wall of the container. When the suction tube is coupled to the container and the pliable sealing ring is sealingly engaged with the interior wall of the container, actuating the actuator mechanism can cause the viscous fluid to be suctioned upwardly through the suction tube and output from the output port, ambient air to be drawn into the container, and the pliable sealing ring to move downwardly.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a partial sectional view of an example pump apparatus according to some implementations of the present disclosure;

FIG. 2 is a perspective view of an example pliable sealing ring utilized in the pump apparatus of FIG. 1;

FIG. 3 is a side view of the example pliable sealing ring of FIG. 2;

FIG. 4 is a perspective view of another example pump apparatus according to some implementations of the present disclosure coupled with a container of viscous fluid;

FIG. 5 is a side view of the example pump apparatus of FIG. 4;

FIG. 6 is a sectional view of the example pump apparatus of FIG. 4;

FIG. 7 is a perspective view of an example nozzle for use with a pump apparatus according to some implementations of the present disclosure;

FIG. 8 is a sectional view of the example nozzle of FIG. 7;

FIG. 9 is a partial sectional view of another example pump apparatus according to some implementations of the present disclosure in a mostly full condition;

FIG. 10 is another partial sectional view of the example pump apparatus of FIG. 9 in a partially full condition;

FIG. 11 is a partial exploded view of yet another example pump apparatus according to some implementations of the present disclosure;

FIG. 12 is a partial sectional view of the example pump apparatus of FIG. 11 in a mostly full condition; and

FIG. 13 is a partial sectional view of the example pump apparatus of FIG. 11 in a partially full condition.

### DETAILED DESCRIPTION

As briefly mentioned above, existing pump apparatus designs can have disadvantages when utilized to pump a viscous fluid. Due to these disadvantages, pumps that use suction are typically replaced by a compression type system in which the fluid is compressed and pushed out of a pump outlet. In this manner, the disadvantages of suction pump apparatuses (e.g., formation of an air channel) can be reduced or eliminated. Compression type pumps, however, have additional disadvantages when compared to a suction type pump. For example only, pumps that utilize compression can be more mechanically complex than suction type pumps, e.g., by requiring a mechanical locking or ratcheting mechanism.

The present disclosure is directed to an improved pump apparatus that addresses the above noted and other deficiencies associated with existing pumps. More specifically, the present disclosure is directed to a suction type pump apparatus that can be utilized to pump viscous fluids out of a container efficiently. Examples of such viscous fluids include, but are not limited to, peanut butter, toothpaste, caulk, mayonnaise, cake frosting/icing, and other similar fluids or liquid suspensions.

The disclosed pump apparatus includes an actuator mechanism coupled to a suction tube through which the viscous fluid can be suctioned. A pliable sealing ring is sealingly engaged with an interior wall of the container in which the viscous fluid is arranged. Actuation of the actuator mechanism suctions the viscous fluid upwardly from a suction port, through the suction tube and out of an output port. As the viscous fluid is suctioned upwardly, ambient air is drawn into the container and the pliable sealing ring moves downwardly. The pliable sealing ring inhibits the ambient air from entering the chamber in which the viscous fluid is arranged, thereby inhibiting the formation of air channel(s) in the viscous fluid reservoir. In this manner, the pliable sealing ring and the viscous fluid in the container is suctioned toward the suction port of the suction tube, in contrast to typical suction type pumps which may also rely on the natural flow of the fluid.

The present disclosure may be particularly useful for pumping peanut butter out of a typical jar of peanut butter. Accordingly, and for ease of description, the remainder of this description will describe peanut butter as the example viscous fluid which is being pumped by the pump apparatus. It should be appreciated, however, that the present disclosure is not so limited and that the present disclosure can be utilized to pump any appropriate fluid.

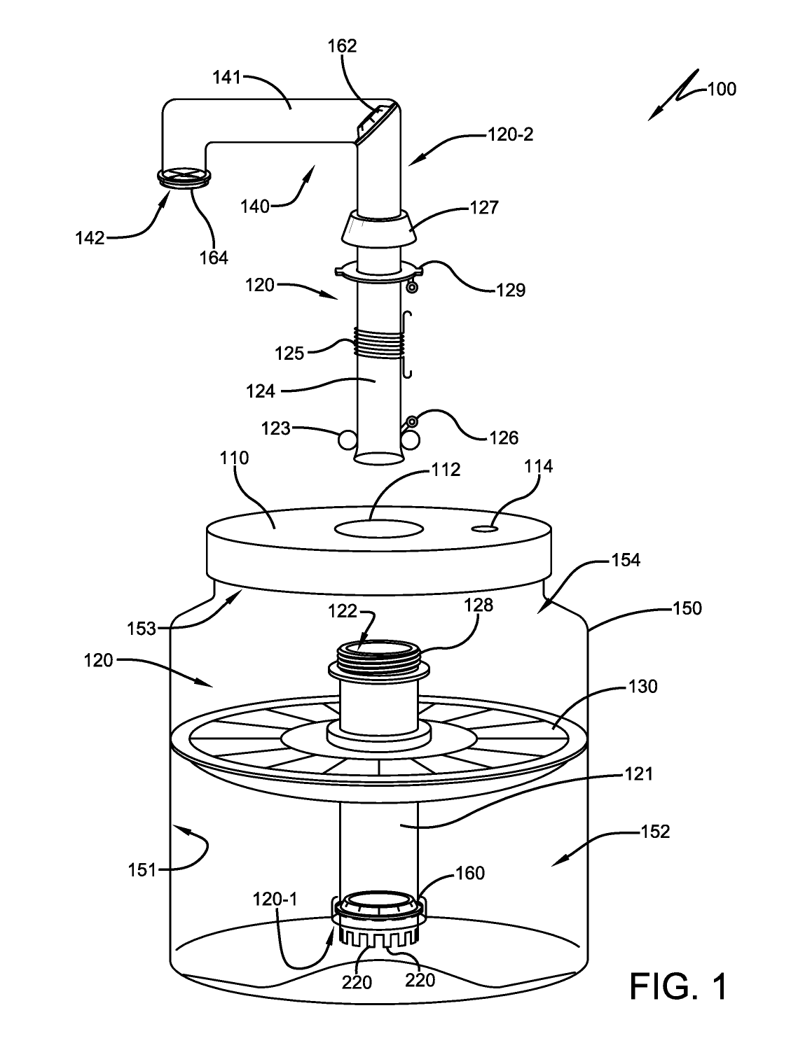

With reference to FIG. 1, a sectional view of an example pump apparatus 100 according to some aspects of the present disclosure is illustrated. The illustrated pump apparatus 100 includes a cap 110, a suction tube 120, a pliable sealing ring 130, and an actuator mechanism 140. The cap 110 can be removably coupled to a container 150 in which the viscous fluid (peanut butter) is arranged. For example only, the cap 110 can be threadingly engaged with threads (not shown) on an opening 153 of the container 150. The cap 110 can define a suction tube aperture 112 through which the suction tube 120 can extend. Additionally, in some implementations, the cap 110 can additionally or alternatively include a venting aperture 114, which is more fully described below.

The suction tube 120 has a first end 120-1 configured to be arranged within an interior of the container 150 and a second end 120-2 fluidly coupled to an output port 142 of the pump apparatus 100 through which the peanut butter is output. The suction tube 120 can include an outer tube 121, an inner tube 124, and a biasing spring 125. In FIG. 1, the suction tube 120 is shown in a disassembled or deconstructed state in which the outer tube 121 is separate from the inner tube 124. In an assembled state, the inner tube 124 is arranged within the outer tube 121 and, in some aspects, the inner tube 124 sealingly engages an inner surface 122 of the outer tube 121, e.g., with a piston ring seal 123.

The illustrated suction tube 120 includes a coupling collar 127 surrounding the inner tube 124 and configured to couple to an engagement section 128 of the outer tube 122. A spring mount 129 can also be coupled to the suction tube 120 and to one end of the biasing spring 125. The second, opposing end of the biasing spring 125 can be coupled to a spring eye hook 126 arranged on the inner tube 124 proximate the piston ring seal 123. In this manner, the biasing spring 125 can bias the actuator mechanism 140 to be in an extended configuration. Although the biasing spring 125 is illustrated as a tension spring, a compression spring can be utilized, mutatis mutandis, instead.

The illustrated actuator mechanism 140 comprises a pump handle 141 coupled to the suction tube 120 and movable between an extended and contracted configuration. In such implementations, actuating the actuator mechanism 140 comprises pumping the pump handle 141 to move the pump handle from the extended to the contracted configuration, and vice versa. The pumping of the pump handle 141 causes the inner tube 124 to move within the outer tube 121.

The pump apparatus 100 can also include one or more valve structures, e.g., to assist in the operation of the pump apparatus 100 and/or to inhibit air from contacting the peanut butter through the outlet port 142. In the illustrated example, the pump apparatus 100 can include a foot valve 160 arranged toward the bottom of the suction tube 120 and a head valve 162 arranged toward a top portion of the suction tube 120. The foot and head valves 160, 162 can assist in maintaining suction in the suction tube 120. The suction tube 120 can optionally include one or more projections 220 arranged on or extending from the first end 120-1. The one or more projections 220 can act to maintain a distance between the first end 120-1 of the suction tube 120 and the bottom wall of the container 150. In this manner, the one or more projections 220 can inhibit the suction tube 120 from sealingly engaging with the bottom of the container 150, e.g., by deformation of the container bottom due to suction, and assist with maintaining an aperture through which the viscous fluid may enter the suction tube 120. Further, in some aspects the outlet port 142 can include an outlet valve 164. In some implementations, and as described more fully below, the outlet valve 164 can be configured to provide a custom shape of the peanut butter output by the pump apparatus 100.

The biasing spring 125 can bias the pump handle 141 to return to the extended configuration. The piston ring seal 123 will be slidingly engaged with the inner surface 122 of the outer tube 121 and, accordingly, will cause a suctioning force to form at the first end 120-1 of the suction tube 120. Additionally, the piston ring seal 123 can also seal the mating interface of the outer tube 121 with the inner tube 124 such that the viscous fluid being pumped through the inner tube 124 will not contact the biasing spring 125. In this manner, the biasing spring 125 can remain relatively unobstructed and operate as intended even during extended use of the pump apparatus 100. It should be appreciated that other configurations of the piston ring seal 123 and biasing spring 125 can be utilized.

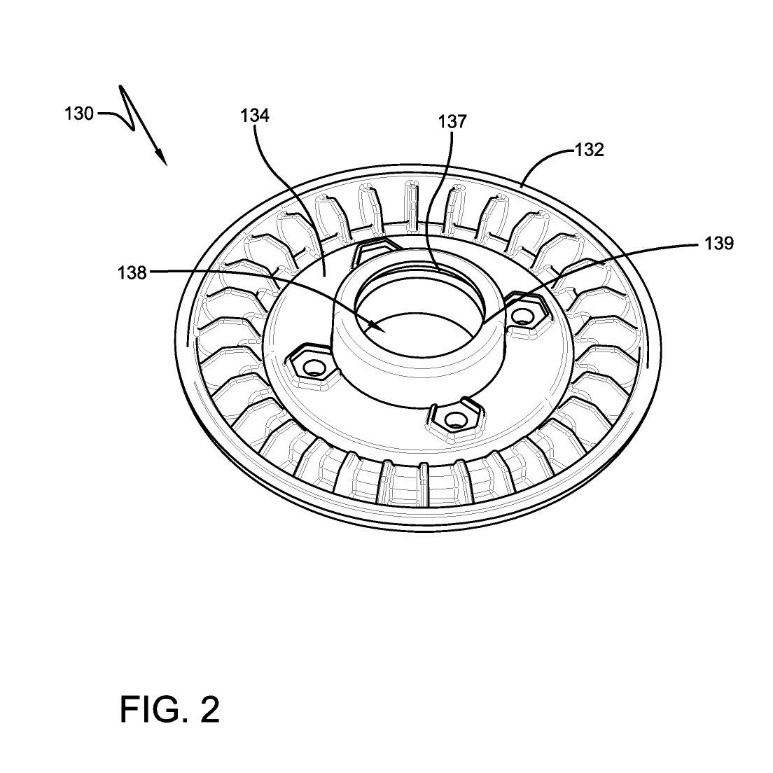

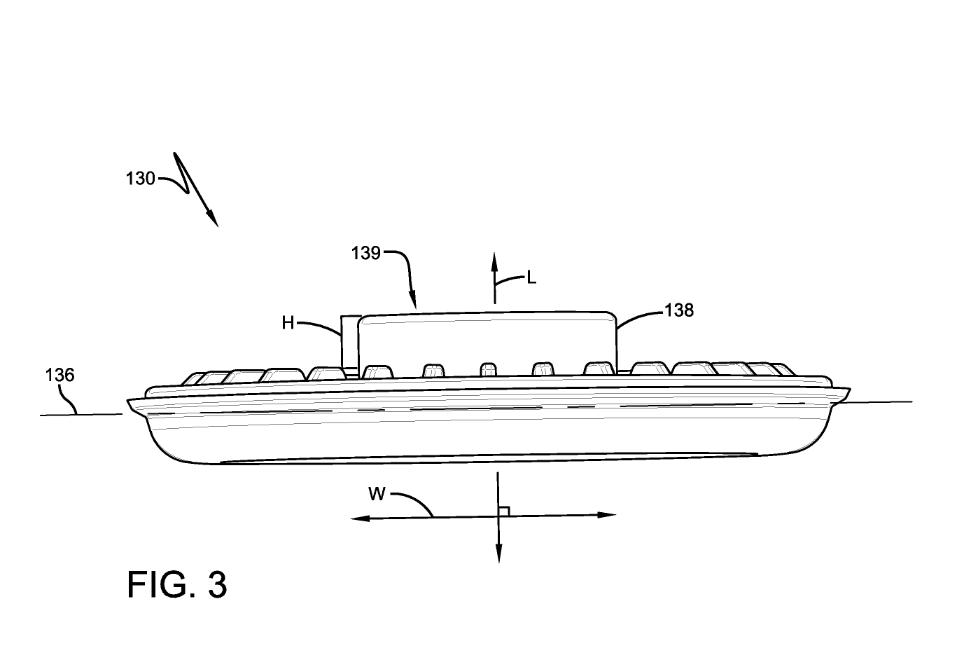

The pliable sealing ring 130, as briefly mentioned above, sealingly engages with an interior wall 151 of the container 150. In some implementations, the pliable sealing ring 130 can be formed of a single piece of elastic material. In alternative implementations, and with further reference to FIGS. 2 and 3, the pliable sealing ring 130 can include a pliable outer sealing portion 132 coupled to an inner rigid base 134. The pliable outer sealing portion 132 is configured to sealingly engage with an interior wall 151 and can be formed of a silicone or other similar material (rubber, plastic, etc.). The pliable outer sealing portion 132 is configured to conform to the interior wall 151 such that an effective sealing arrangement can be maintained. The inner rigid base 134 can be formed of a different material and is configured to provide stiffness to the pliable sealing ring 130. In further alternative implementations, the pliable sealing ring 130 can be replaced with a rigid sealing ring (not separately shown). In such implementations, the rigid sealing ring may or may not fully sealingly engage with the interior wall 151 of the container 150 depending on the requirements of the viscous fluid being pumped.

As best shown in FIG. 3, the inner rigid base 134 can define a base plane 136 that extends in a lengthwise direction W. The inner rigid base 134 can also include a collar 137 that extends in a longitudinal direction L that is perpendicular to the lengthwise direction W. Accordingly, the collar 137 can have a height H that extends in the longitudinal direction L. The collar 137 can further define a sealing ring aperture 138 through which the suction tube 120 can extend. The collar 137 can also include a seal 139 for sealingly engaging with the suction tube 120.

The pliable sealing ring 130 can be configured to be inserted in a compressed state (not shown) through the opening 153 of the container 150. For example only, the pliable outer sealing portion 132 can be bent, contorted, squeezed, or otherwise compressed to fit through the opening 153 of the container 150, which is generally smaller (e.g., in diameter) than the interior of the container 150 itself. In some implementations, the pliable sealing ring 130 can be configured to automatically expand to its expanded state to sealingly engage with the interior wall 151 of the container 150 upon insertion through the opening 153. In other aspects, the pliable sealing ring 130 can be configured to be manually inflated to its expanded state to sealingly engage with the interior wall 151 of the container 150 after insertion through the opening 153.

As mentioned above, as the peanut butter is suctioned out of the container 150 the pliable sealing ring 130 will move downwardly. As the suction force is generated on the peanut butter, and depending on the construction of the suction tube 120, the arrangement/consistency/etc. of the peanut butter, and other factors, it is possible that the suction force will apply unevenly on the pliable sealing ring 130, thereby creating an asymmetric force that will act to tilt or otherwise distort the pliable sealing ring 130, e.g., thereby breaking the seal engagement and creating the possibility that an air channel may form. In such situations the collar 137 can provide a rigid support such that the pliable sealing ring 130 can move downwardly along the suction tube 120 while maintaining its orientation in the base plane 136.

In operation, the pump apparatus 100 of the present disclosure will operate as follows. The pliable sealing ring 130 can be inserted into the container 150 by a user. As mentioned above, upon insertion the pliable sealing ring 130 will expand to or otherwise sealingly engage with the interior wall 151 of the container 150. In implementations that utilize the rigid sealing ring, a user may fully insert the rigid sealing ring into the container 150 and into contact with the interior wall 151 thereof. Upon insertion, the pliable sealing ring 130 will essentially partition the container 150 into a first chamber 152 and a second chamber 154. The peanut butter (or other viscous fluid) will be arranged within the first chamber 152. As discussed more fully below, ambient air will be drawn into the second chamber 154 during actuation of the actuating mechanism 140.

As a user actuates the actuator mechanism 140, e.g., by pumping the pump handle 141, the inner tube 124 will slide within the outer tube 121, thereby creating a suction in the first chamber 152. Peanut butter will be suctioned upwardly through the suction tube 120 (e.g., inner tube 124) and output from the output port 142. Ambient air can be drawn into the second chamber 154 of the container 150, e.g., through the venting aperture 114. The pliable sealing ring 130, as it is sealingly engaged with the interior wall 151 of the container 150, can inhibit ambient air from entering the first chamber 152, thereby inhibiting the formation of air channels in the peanut butter. The resulting suction created in the first chamber 152 will cause the pliable sealing ring 130 to move downwardly in the container 150.

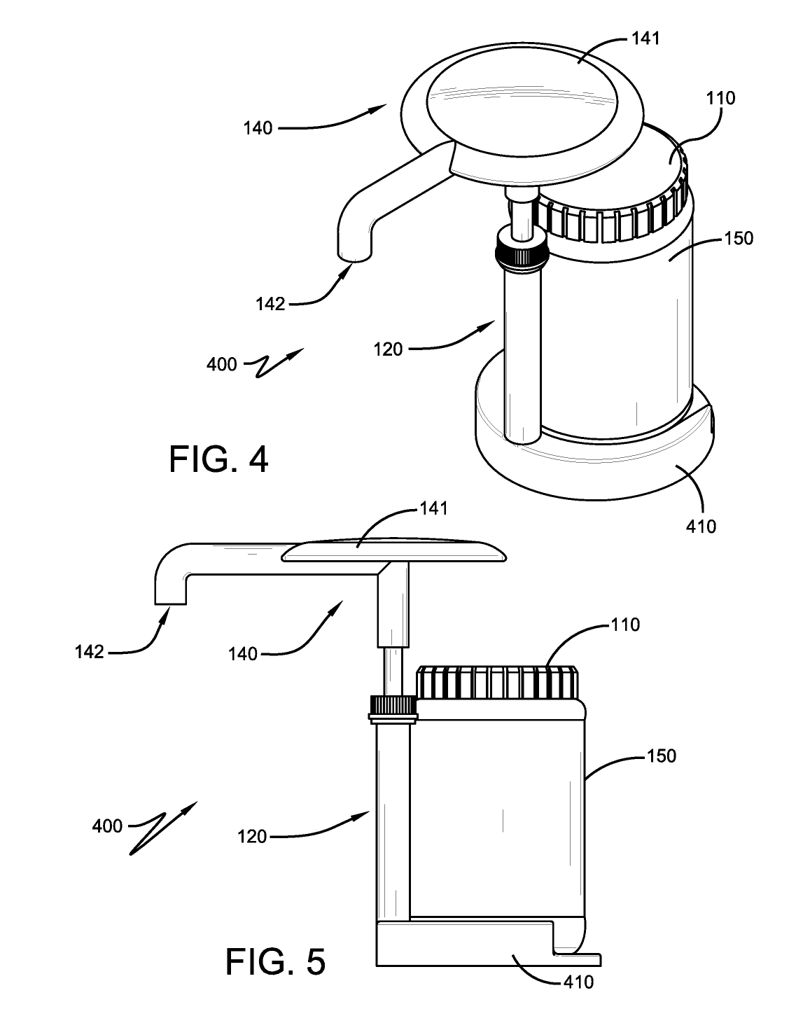

With reference to FIGS. 4-6, another example pump apparatus 400 according to some aspects of the present disclosure is illustrated. Pump apparatus 400 can include many of the same components as the pump apparatus 100 of FIGS. 1-3. For example only, the pump apparatus 400 can include a suction tube 120, a pliable sealing ring 130, and an actuator mechanism 140 similar to those described above. One difference between the pump apparatus 100 and the pump apparatus 400 is that, in pump apparatus 400, the suction tube 120 does not extend through the pliable sealing ring 130, as more fully discussed below.

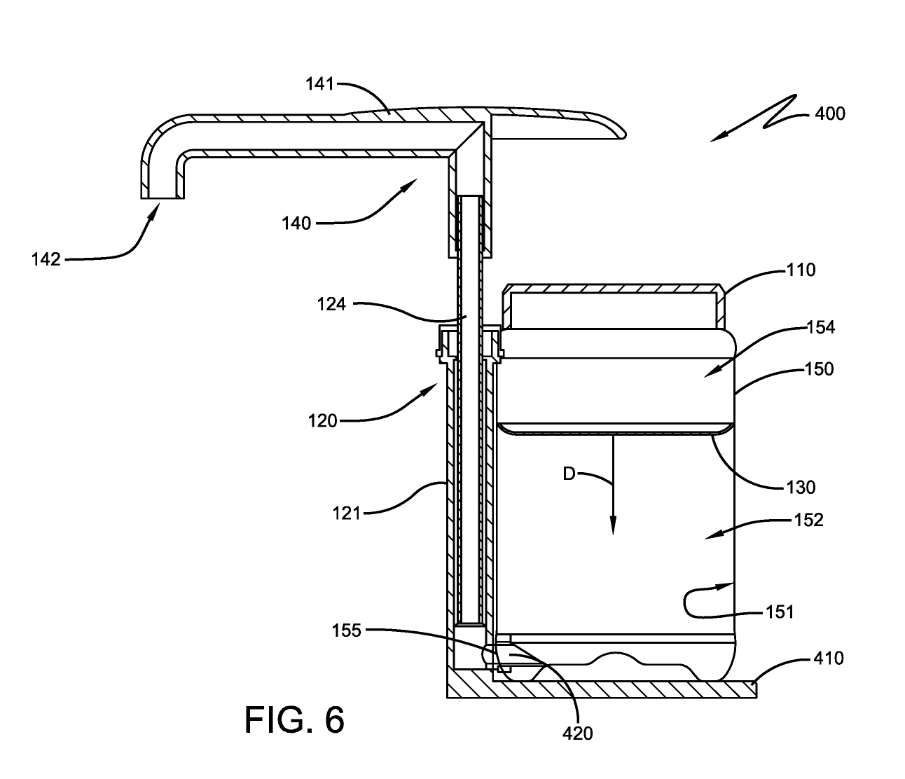

The pump apparatus 400 can be configured to mate with a container 150. More specifically, and as best shown in FIG. 6, the container 150 can be arranged on a pump base 410. The suction tube 120 can include a mating port 420 that can sealingly couple to the container 150. In some aspects, the mating port 420 can puncture and sealingly engage with the container 150 upon slidingly coupling the container on the pump base 410 (e.g., if the container is made of a plastic, metal, or similar material that is capable of being punctured). Alternatively or additionally, the container may include an engagement port 155 that sealingly couples to the mating port 420. Other arrangements are contemplated.

The pliable sealing ring 130 can be inserted into the container 150, as described above, to form the first chamber 152 and the second chamber 154. As a user actuates the actuator mechanism 140, e.g., by pumping the pump handle 141, a suction will be created in the first chamber 152 and peanut butter will be suctioned upwardly through the suction tube 120 (e.g., inner tube 124) and output from the output port 142. Ambient air can be drawn into the second chamber 154 of the container 150, e.g., through a venting aperture 114 as described above. The pliable sealing ring 130, as it is sealingly engaged with the interior wall 151 of the container 150, can inhibit ambient air from entering the first chamber 152, thereby inhibiting the formation of air channels in the peanut butter. The resulting suction created in the first chamber 152 will cause the pliable sealing ring 130 to move downwardly (the D direction as illustrated) in the container 150.

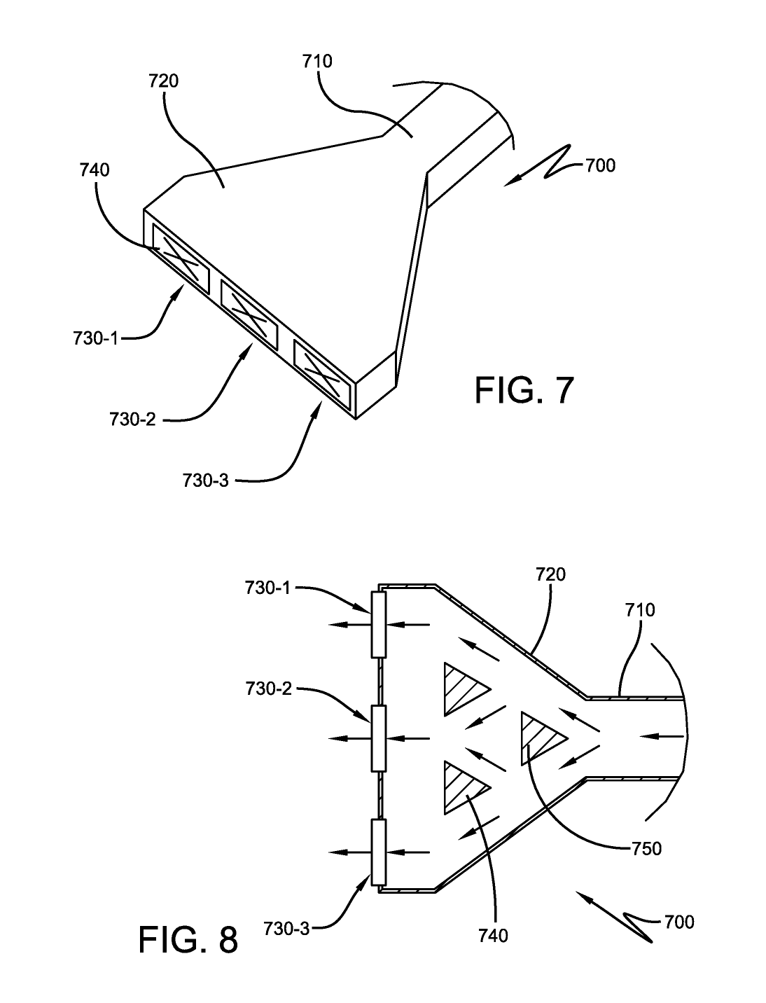

With reference to FIGS. 7 and 8, an example nozzle 700 for use with the pump apparatuses 100, 400 according to some implementations of the present disclosure is illustrated. The nozzle 700 can be inserted within or replace the outlet port 142 to provide a custom shape to the peanut butter that is output by the pump apparatus 100, 400. For example only, the nozzle 700 can include an insertion portion 710 coupled to a main body portion 720. The insertion portion 710 can be configured to be inserted into the outlet port 142 to fluidly couple the nozzle 700 to the suction tube 120.

The main body portion 720 can expand outwardly from the insertion portion 710. In the illustrated example, the nozzle 700 includes three outlet ports 730-1, 730-2, 730-3 through which the peanut butter is output. Each outlet port 730 can include a valve 740 (e.g., a duckbill valve or similar) that permits the peanut butter to be output but inhibits the flow of air or other material into the nozzle 700. As best shown in FIG. 8, the nozzle 700 can include one or more baffle structures 750. The baffle structures 750 act to direct the output flow of peanut butter from the 710 insertion portion and out of the outlet ports 730, e.g., such that the flow rate of each of the outlet ports 730 is substantially equal (+/−10%). The illustrated nozzle 700 is intended to output three separate flows of peanut butter that can merge to form a relatively wide “band” of peanut butter, which may be particularly useful while making a peanut butter sandwich. Other forms of the nozzle 700 are contemplated by the present disclosure.

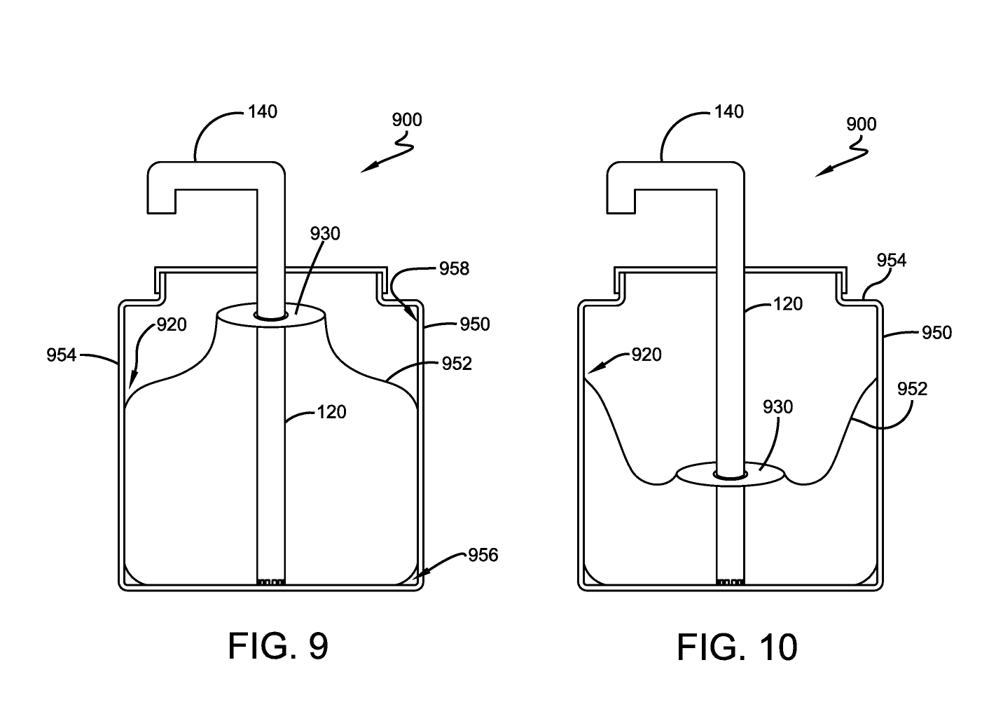

With reference to FIGS. 9 and 10, another example pump apparatus 900 according to some aspects of the present disclosure is illustrated. Pump apparatus 900 can include many of the same components as the pump apparatus 100 of FIGS. 1-3 and the pump apparatus 400 of FIG. 4-6. For example only, the pump apparatus 900 can include a suction tube 120 and an actuator mechanism 140 similar to those described above. One difference between the pump apparatus 900 and the pump apparatuses 100, 400 is that, in pump apparatus 900, there is no pliable sealing ring 130 as the container 950 in which the viscous fluid is arranged includes a pliable containment structure 952 (illustrated as a bag or balloon-like structure) that is configured to deform in a manner, described below, to assist with the suction and output of the viscous fluid.

The pump apparatus 900 includes a sliding sealing ring 930 that is sealingly engaged with the pliable containment structure 952. The sliding sealing ring 930 can be configured to slide downwardly on the suction tube 120 as viscous fluid is dispensed, as more fully described below. The pliable containment structure 952 can be arranged within and coupled to a rigid containment structure 954. In some implementations, the pliable containment structure 952 can be fixedly secured to an interior of the rigid containment structure 954, e.g., by an adhesive(s) 920 or other coupling mechanism. In the illustrated example of FIGS. 9 and 10, the pliable containment structure 952 is fixedly secured to a bottom wall 956 of the rigid containment structure 954, as well as fixedly but releasably coupled to an interior sidewall 958 of the rigid containment structure 954.

As viscous fluid is dispensed from the container 950, the pliable containment structure 952 can be configured to deform in a specific manner such that the suction tube 120 maintains a fluid coupling with the viscous fluid and does not sealingly engage with the pliable containment structure 952. For example only, the sliding sealing ring 930 can be pulled downwardly (by suction) along the suction tube 120 as viscous fluid is dispensed. As the sliding sealing ring 930 moves downwardly, a force on the pliable containment structure 952 can be generated and which can separate the pliable containment structure 952 from the rigid containment structure 954. As shown in FIG. 10, the force generated can detach the pliable containment structure 952 from the rigid containment structure 954 by overcoming the coupling force of the adhesive 920.

The pliable containment structure 952 may be manufactured to include pleats, seams, folds, creases, or other mechanical components that cause the pliable containment structure 952 to deform in a specific manner. More specifically, the pliable containment structure 952 can be constructed to deform from the top down to ensure that the suction tube 120 will maintain fluid coupling with the viscous fluid therein. In the illustrated example, the adhesive 920 is utilized to maintain the pliable containment structure 952 in contact with the sidewalls of the rigid containment structure 954 at the top such that the pliable containment structure 952 does not collapse around the bottom of the suction tube 120.

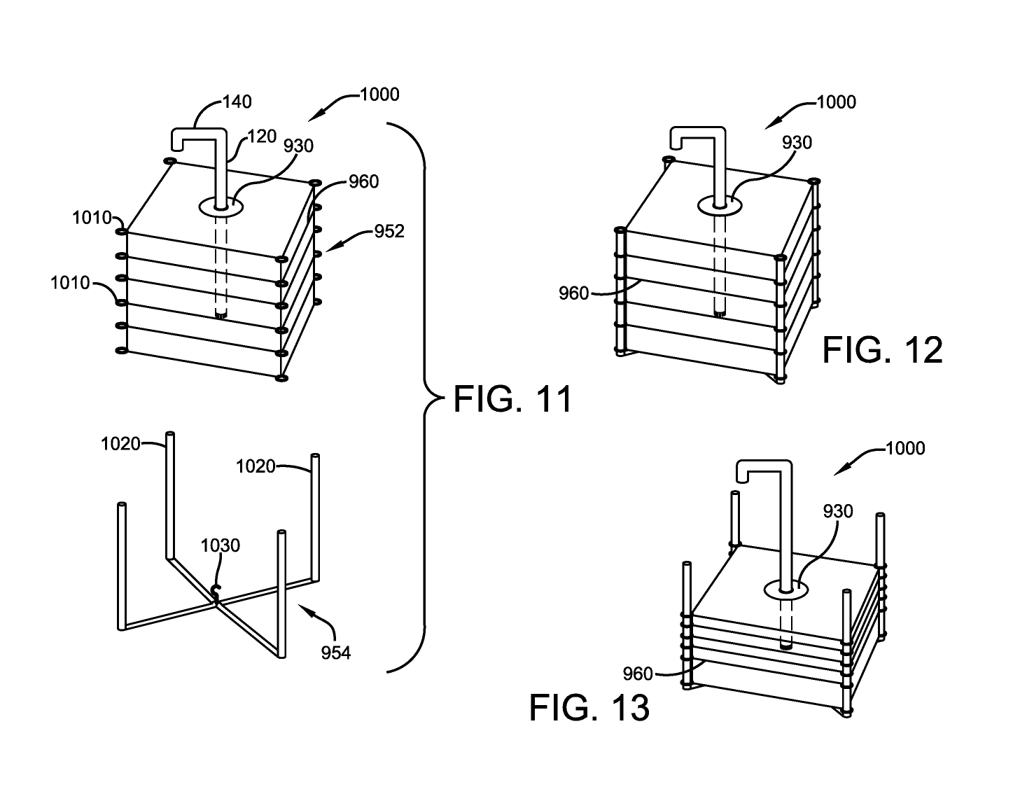

With reference to FIGS. 11-13, another example pump apparatus 1000 according to some aspects of the present disclosure is illustrated. Pump apparatus 1000 is similar to and can include many of the same components as the pump apparatus 900 of FIGS. 9 and 10. For example only, the pump apparatus 1000 can include a suction tube 120 and an actuator mechanism 140 similar to those described above. One difference between the pump apparatus 1000 and the pump apparatus 900 is that, in pump apparatus 1000, the pliable containment structure 952 is fixedly secured to an interior of the rigid containment structure 954 via a different coupling mechanism than pump apparatus 900.

The pliable containment structure 952 of pump apparatus 1000 can be configured to include pleats, seams, folds, creases, or other mechanical components 960 that cause the pliable containment structure 952 to deform in a specific manner. More specifically, the pliable containment structure 952 can be constructed to deform from the top down to ensure that the suction tube 120 will maintain fluid coupling with the viscous fluid therein. In the illustrated example, a plurality of coupling rings 1010 is utilized to couple the pliable containment structure 952 to the rigid containment structure 954. More specifically, the coupling rings 1010 can slidingly engage with support arms 1020 of the rigid containment structure 954. Further, a coupling mechanism 1030 (illustrated as a hook) can fixedly secured the bottom of the pliable containment structure 952 to the rigid containment structure 954.

As shown in FIG. 12, in the mostly full condition, the coupling rings 1010 can extend along the full length of the support arms 1020. As shown in FIG. 13, which illustrates a partially fully condition, the coupling rings 1010 at the top have moved downwardly along the support arms 1020 as the pliable containment structure 952 has deformed due to pump suction. Similar to the pump apparatus 900 described above, a sliding sealing ring 930 can move downwardly to collapse the pliable containment structure 952 as viscous fluid is dispensed. As the sliding sealing ring 930 moves downwardly, the pleats, seams, folds, creases, or other mechanical components 960 can cause the pliable containment structure 952 to deform in a specific manner such that the suction tube 120 will maintain fluid coupling with the viscous fluid therein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A pump apparatus for a viscous fluid, comprising:
a cap configured to be removably coupled to a container in which the viscous fluid is arranged, the cap defining a suction tube aperture;
a suction tube extending through the suction tube aperture and having a first end and a second end, the first end configured to be arranged in an interior of the container and the second end being fluidly coupled to an output port for outputting the viscous fluid;
a pliable sealing ring sealingly engaged with the suction tube, the pliable sealing ring being configured to further sealingly engage with an interior wall of the container; and
an actuator mechanism coupled to the suction tube,
wherein, when the first end of the suction tube is arranged in the viscous fluid in the interior of the container and the pliable sealing ring is sealingly engaged with the interior wall of the container, actuating the actuator mechanism causes:
the viscous fluid to be suctioned upwardly through the suction tube and output from the output port,
ambient air to be drawn into the container, and
the pliable sealing ring to move downwardly.

2. The pump apparatus of claim 1, wherein the actuator mechanism comprises a pump handle, wherein actuating the actuator mechanism comprises pumping the pump to move the pump handle from an extended configuration to a contracted configuration and vice versa.

3. The pump apparatus of claim 1, further comprising the container, wherein the cap is threadingly engaged with threads formed on an opening of the container.

4. The pump apparatus of claim 3, wherein the pliable sealing ring is configured to be inserted through the opening of the container in a compressed state.

5. The pump apparatus of claim 4, wherein the pliable sealing ring is configured to automatically expand to sealingly engage with the interior wall of the container upon insertion through the opening of the container.

6. The pump apparatus of claim 4, wherein the pliable sealing ring is configured to be manually inflated to expand to sealingly engage with the interior wall of the container after insertion through the opening of the container.

7. The pump apparatus of claim 1, wherein the cap further defines a venting aperture through which ambient air is drawn into the container during the actuating of the actuator mechanism.

8. The pump apparatus of claim 1, wherein, when the pliable sealing ring is inserted into the container and sealingly engages with the interior wall of the container, the pliable sealing ring partitions the container into a first chamber in which the viscous fluid is arranged and a second chamber into which the ambient air is drawn during actuation of the actuating mechanism.

9. The pump apparatus of claim 8, wherein the pliable sealing ring inhibits ambient air from entering the first chamber during actuation of the actuating mechanism.

10. The pump apparatus of claim 1, wherein the pliable sealing ring is formed of a single piece of elastic material.

11. The pump apparatus of claim 1, wherein the pliable sealing ring comprises:
a pliable outer sealing portion;
an inner rigid base coupled to the pliable outer sealing portion, the inner rigid base defining a base plane extending in a lengthwise direction and including a collar extending in a longitudinal direction that is perpendicular to the lengthwise direction,
wherein the collar defines a sealing ring aperture through which the suction tube extends.

12. A pump apparatus for a viscous fluid, comprising:
a suction tube configured to be removably coupled to a container in which the viscous fluid is arranged, the suction tube having a first end and a second end, the first end configured to be fluidly coupled to an interior of the container and the second end being fluidly coupled to an output port for outputting the viscous fluid;
a pliable sealing ring configured to sealingly engage with an interior wall of the container; and
an actuator mechanism coupled to the suction tube,
wherein, when the suction tube is coupled to the container and the pliable sealing ring is sealingly engaged with the interior wall of the container, actuating the actuator mechanism causes:
the viscous fluid to be suctioned upwardly through the suction tube and output from the output port,
ambient air to be drawn into the container, and
the pliable sealing ring to move downwardly.

13. The pump apparatus of claim 12, wherein the actuator mechanism comprises a pump handle, wherein actuating the actuator mechanism comprises pumping the pump to move the pump handle from an extended configuration to a contracted configuration and vice versa.

14. The pump apparatus of claim 12, wherein the pliable sealing ring is configured to be inserted through an opening of the container in a compressed state.

15. The pump apparatus of claim 12, wherein the pliable sealing ring is configured to automatically expand to sealingly engage with the interior wall of the container upon insertion through the opening of the container.

16. The pump apparatus of claim 12, wherein the pliable sealing ring is configured to be manually inflated to expand to sealingly engage with the interior wall of the container after insertion through the opening of the container.

17. The pump apparatus of claim 12, wherein, when the pliable sealing ring is inserted into the container and sealingly engages with the interior wall of the container, the pliable sealing ring partitions the container into a first chamber in which the viscous fluid is arranged and a second chamber into which the ambient air is drawn during actuation of the actuating mechanism.

18. The pump apparatus of claim 17, wherein the pliable sealing ring inhibits ambient air from entering the first chamber during actuation of the actuating mechanism.

19. The pump apparatus of claim 12, wherein the pliable sealing ring comprises:
a pliable outer sealing portion;
an inner rigid base coupled to the pliable outer sealing portion, the inner rigid base defining a base plane extending in a lengthwise direction and including a collar extending in a longitudinal direction that is perpendicular to the lengthwise direction,
wherein the collar defines a sealing ring aperture through which the suction tube extends.

20. The pump apparatus of claim 12, wherein the pliable sealing ring is formed of a single piece of elastic material.
